(19) United States
(12) Patent Application Publication
(10) Pub. No.: US 2013/0095286 A1
(43) Pub. Date: Apr. 18, 2013

(54) OPTICAL RECORDING MEDIUM

(71) Applicants: Yo Ota, Tokyo (JP); Takashi Iwamura, Tokyo (JP); Mitsuaki Oyamada, Tokyo (JP); Daisuke Ueda, Tokyo (JP)

(72) Inventors: Yo Ota, Tokyo (JP); Takashi Iwamura, Tokyo (JP); Mitsuaki Oyamada, Tokyo (JP); Daisuke Ueda, Tokyo (JP)

(73) Assignee: SONY CORPORATION, Tokyo (JP)

(21) Appl. No.: 13/805,969

(22) PCT Filed: Jun. 24, 2011
(86) PCT No.: PCT/JP2011/065137

§ 371 Date: Dec. 20, 2012

(30) Foreign Application Priority Data
Jul. 6, 2010 (JP) 2010-153553

(51) Int. Cl. G11B 7/24035

(52) U.S. Cl. CPC G11B 7/24035
USPC 428/131

(57) ABSTRACT

A recording layer is formed from an organic material (thermoplastic resin, thermosetting resin) having an oxygen element ratio of 9.1% or more. Examples include polyethersulfone, polyimide, and polyethylene. Alternatively, the recording layer is formed from a material in which a low-molecular compound is added to a resin and which has an oxygen element ratio after mixing of 9.1% or more.

### TECHNICAL FIELD

The present invention relates to a bulk type optical recording medium which records information on the basis of hole marks and, in particular, relates to a recording layer material.

### BACKGROUND ART

Optical disc systems, e.g., CD (Compact disc), DVD (Digital Versatile Disc), and Blue-ray Disc (Blue-ray Disc: registered trademark), read fine reflectivity changes formed on one surface of a disc in the same noncontact manner as that of an objective lens of a microscope.

It is well known that the size of a light spot on a disc is substantially specified by λ/NA (λ: wavelength of illumination light, NA: numerical aperture), and the resolving power is also proportional to this value.

Meanwhile, a method in which a plurality of recording layers are formed in the depth direction of a disc and a method in which recording in a multilayer state is performed into a bulk type (volume type) recording medium so as to increase the capacity of a disc have been known.

In particular, as for a promising method for increasing the capacity of an optical recording medium, a method in which tens of recording layers are formed in the thickness direction in a bulk recording material is mentioned, and a method in which holes are formed as marks and information is recorded has been proposed, as disclosed in Japanese Unexamined Patent Application Publication No. 2008-176902.

In the case where recording is performed into a bulk type recording medium, recording and reproduction are performed by applying high-density light to plastic having a refractive index of about 1.5 and using holes, which are filled with a gas having a refractive index of about 1.0, as marks.

In this regard, Japanese Unexamined Patent Application Publication No. 2009-274225 and Japanese Unexamined Patent Application Publication No. 2005-37658 disclose recording layer materials in which a recording mark is formed by two-photon absorption.

### DISCLOSURE OF INVENTION

### Technical Problem

In a recording and reproduction system in which hole (void) marks are formed in a bulk type recording layer, reproduction laser light is applied to a mark line of voids, and reproduction data are obtained from signals obtained from the reflected light thereof.

However, the signals reproduced from the mark line of voids include noise components. As the noise level is degraded, the reproduction signal quality is degraded. This leads to a reduction in reliability of the recording and reproduction system. For example, degradation in error rate and an increase in capacity consumption due to defect recording are induced.

Accordingly, it is an object of the present invention to improve the quality of the hole mark and improve the reliability of the recording and reproduction system in which hole marks (voids) are formed in a bulk type recording layer.

### Technical Solution

An optical recording medium according to the present invention is an optical recording medium including a bulk type recording layer in which hole marks are formed by laser light irradiation, wherein the above-described recording layer is formed from an organic material (thermoplastic resin or thermosetting resin) having an oxygen element ratio of 9.1% or more.

Alternatively, the oxygen element ratio of the above-described organic material is specified to be 25% or less.

More specifically, the above-described organic material is any one of polyethersulfone, polyimide, polyethylene, polyoxymethylene, polymethyl methacrylate, polyvinyl acetate, diallyl phthalate, polyamide imide, and polyurethane.

In this regard, the recording layer may be formed by mixing a plurality of these organic materials having an oxygen element ratio of 9.1% or more.

In addition, an optical recording medium according to the present invention is an optical recording medium including a bulk type recording layer in which hole marks are formed by laser light irradiation, wherein the above-described recording layer is formed from a material in which a low-molecular compound is added to an organic material and which has an oxygen element ratio of 9.1% or more.

The above-described material is a material having an oxygen element ratio of 9.1% or more adjusted by adding a low-molecular compound to an organic material having an oxygen element ratio of less than 9.1%.

Alternatively, the above-described material is a material having an oxygen element ratio of 9.1% or more adjusted by adding a low-molecular compound to an organic material having an oxygen element ratio of 9.1% or more.

A primary component of a noise in a reproduction signal from a recording mark on the basis of a hole (void) is contamination (soot) generated in decomposition of an organic material constituting a recording layer due to heat or light. It is possible to reduce noises by forming a void including reduced soot and having a clean shape.

In order to remove soot, the organic material constituting the recording layer may be subjected to complete combustion. For this purpose, it is effective to increase the oxygen element ratio in the recording layer and, thereby, facilitate gasification of the organic material.

### Advantageous Effects

According to the present invention, the recording layer is formed from a material having an oxygen element ratio of 9.1% or more, so that soot does not remain easily in formation of a void and a void having a clean shape can be formed. Consequently, appearance of noises in reproduction signals can be reduced and the reliability of the recording and reproduction system can be improved.

### BRIEF DESCRIPTION OF DRAWINGS

FIG. 1 is an explanatory diagram of an optical recording medium according to an embodiment of the present invention.

FIG. 2 is an explanatory diagram of servo control of an optical recording medium according to an embodiment.

FIG. 3 (a) and FIG. 3 (b) are explanatory diagrams (photographs) of a void with a large noise level and a void with a small noise level.

FIG. 4 (a) and FIG. 4 (b) are explanatory diagrams of a void structure and a signal level.

FIG. 5 (a) and FIG. 5 (b) are explanatory diagrams of the relationship between the oxygen element ratio and the noise level.

FIG. 6 is an explanatory diagram of organic materials which are used in embodiments and which have oxygen element ratios of less than 9.1%.

FIG. 7 is an explanatory diagram of organic materials which are used in embodiments and which have oxygen element ratios of less than 9.1%.

FIG. 8 is an explanatory diagram of organic materials which are used in embodiments and which have oxygen element ratios of 9.1% or more.

FIG. 9 is an explanatory diagram of organic materials which are used in embodiments and which have oxygen element ratios of 9.1% or more.

FIG. 10 is an explanatory diagram of thermosetting resins used in embodiments.

FIG. 11 (a) to FIG. 11 (c) are explanatory diagrams in the case where a low-molecular compound is added to a resin in an embodiment.

FIG. 12 is an explanatory diagram of low-molecular compounds used in embodiments.

FIG. 13 is an explanatory diagram of low-molecular compounds used in embodiments.

FIG. 14 (a) and FIG. 14 (b) are flow charts of recording layer production procedures in embodiments.

### BEST MODES FOR CARRYING OUT THE INVENTION

The embodiments according to the present invention will be described below in the following order. Optical recording media in the embodiments record information by forming hole marks in a bulk layer.

### <1. Structure of Optical Recording Medium in Embodiment>

<2. Recording and Reproduction with Respect to Optical Recording Medium>

### <3. Relationship Between Void and Noise and Suitability for Bulk Layer Material>

<4. Bulk Layer Material Made from Resin>
<5. Bulk Layer Material Made from Resin+Low-Molecular Compound>

### <1. Structure of Optical Recording Medium in Embodiment>

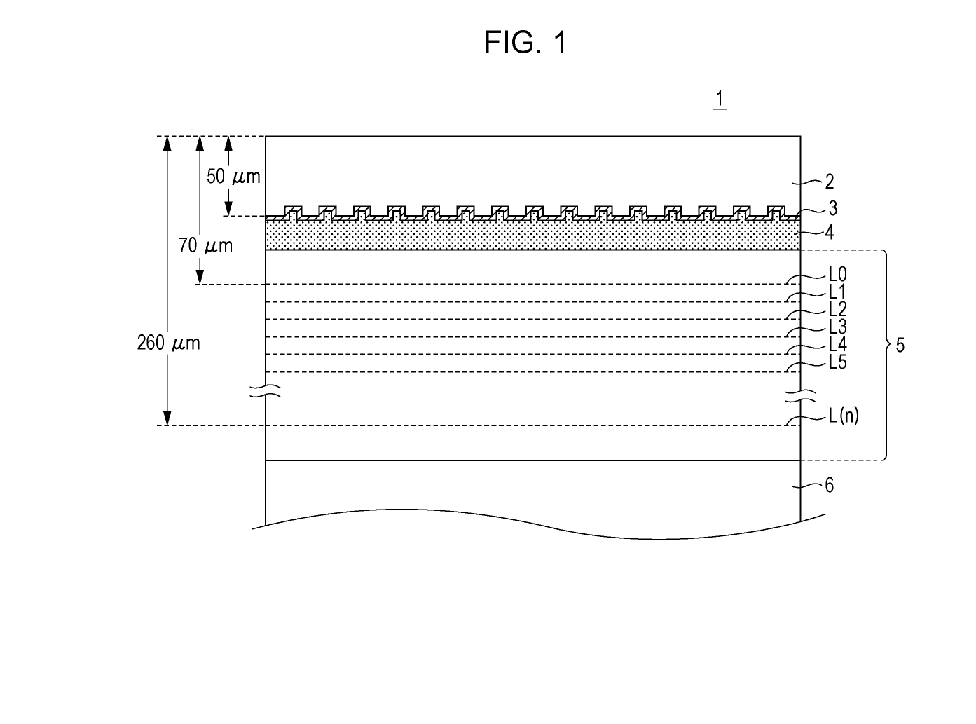

FIG. 1 shows a cross-sectional structural diagram of a bulk type optical recording medium (optical recording medium 1) in the embodiment.

The optical recording medium 1 shown in FIG. 1 concerned is specified to be a disc-shaped optical recording medium, and mark recording (information recording) is performed by application of laser light to the optical recording medium 1 driven to rotate. Meanwhile, reproduction of recorded information is also performed by application of laser light to the optical recording medium 1.

In this regard, the optical recording medium refers to a recording medium in which the recorded information is reproduced by application of light.

In the present example, so-called holes (voids) are formed as recording marks.

A void recording system is a technique in which laser light is applied at a relatively high power to a bulk layer (recording layer) formed from a predetermined recording material and, thereby, a hole (void) is recorded in the above-described bulk layer (recording layer). The thus formed hole portion is a portion having a refractive index different from the refractive index of the other portion in the bulk layer and the reflectivity of light increases at the interface portion therebetween. Consequently, the above-described hole portion functions as a recording mark and, thereby, information recording on the basis of formation of the hole mark is realized.

The bulk layer (recording layer) is formed from a photoreactive resin.

It is preferable that the recording mark be formed from the photoreactive resin by a multiphoton absorption reaction. In the multiphoton absorption reaction, a photoreaction is effected by absorption of the light in the vicinity of a focus, at which the light intensity is high, of the laser light for recording.

In the photoreactive resin, part of the photoreactive resin is vaporized because of boiling or decomposition due to heat generation in accordance with the photoreaction and a bubble serving as a recording mark is formed in the vicinity of the focus of the laser light. This portion serves as a hole mark.

Here, in general, in a one-photon absorption reaction in which a photoreaction is effected by absorption of one photon, the recording mark formation time is substantially inversely proportional to the light intensity of the recording laser light. Meanwhile, in a two-photon absorption reaction in which a photoreaction is effected by absorption of two photons, the recording mark formation time is substantially inversely proportional to the square of the light intensity of the recording laser light. The fact that the recording mark formation time is inversely proportional to the square of the light intensity has an advantage from the viewpoints of an improvement in recording density, prevention of interference between recording marks, and the like in the case where a small size recording mark is formed because the recording mark can be formed only in a portion at which the light intensity is very high in a recording laser spot.

The optical recording medium 1 shown in FIG. 1 is specified to be a so-called bulk type optical recording medium and is provided with a cover layer 2, a selective reflection film 3, an intermediate layer 4, a bulk layer 5, and a substrate 6 in that order from the upper layer side, as shown in the drawing.

Here, the term “upper layer side” in the present specification refers to the upper layer side, where a surface on which the laser light from the recording and reproduction apparatus side is incident is specified to be an upper surface. In addition, the terms “depth direction” and “thickness direction” refer to directions coincident with the vertical direction following the definition of the above-described term “upper layer side” (that is, a direction parallel to the incident direction of the laser light from the recording and reproduction apparatus side) in FIG. 1.

In the optical recording medium 1, the cover layer 2 is formed from a resin, e.g., polycarbonate or acryl, and the lower surface side thereof is provided with an uneven cross-sectional shape along with formation of a guide channel to guide a recording/reproduction position, as shown in the drawing. The guide channel is disposed in a spiral shape when viewed from a disc plan view direction.

The above-described guide channel is formed from a continuous channel (groove) or a pit line. For example, in the case where the guide channel is a groove, the groove concerned is formed in such a way as to meander periodically and, thereby, position information (absolute position information: for example, rotation angle information and radial position information) can be recorded on the basis of the periodic information of the meandering concerned.

The cover layer 2 is produced by injection forming using a stamper provided with such a guide channel (uneven shape) or the like.

Meanwhile, the selective reflection film 3 is formed on the lower surface side of the cover layer 2 provided with the above-described guide channel.

Here, in a bulk recording system, in general, servo light (may be referred to as second laser light), which is different from the recording light (hereafter may be referred to as first laser light) to perform mark recording, to obtain error signals of tracking and focus is applied separately on the basis of the above-described guide channel to the bulk layer 5 serving as a recording layer.

At this time, if the above-described servo light reaches the bulk layer 5, the mark recording in the bulk layer 5 concerned may be adversely affected. Consequently, a selective reflection film having selectivity to reflect the servo light and transmit the recording light is necessary, in general.

In the bulk recording system, the laser light used for the recording light and the laser light used for the servo light are specified to have different wavelengths. In order to respond this, a selective reflection film, which has the selectivity to reflect light in the same wavelength band as the servo light and transmit light with a wavelength other than that, is used as the selective reflection film 3.

The bulk layer 5 serving as a recording layer is disposed on the lower layer side of the selective reflection film 3 with the intermediate layer 4 formed from an adhesion material, e.g., an UV curable resin, therebetween.

The material for forming the bulk layer 5 (recording material) will be described later.

The bulk layer 5 is subjected to information recording on the basis of hole mark formation by focusing the laser light on the individual predetermined positions in the depth direction of the bulk layer 5 sequentially.

Therefore, in the recording medium 1 having been subjected to recording, a plurality of mark-formed layers (information recording layers) L are disposed in the bulk layer 5. Many (the number is n+1) information recording layers are disposed and are indicated as the information recording layers L0 to L(n) in the drawing.

Although the thickness, the size, and the like of the bulk layer 5 are not certain, for example, in the case where application of blue laser light (wavelength 405 nm) by an optical system with NA of 0.85 is considered, it is appropriate that the information recording layers be formed at positions 50 μm to 300 μm from a disc surface (surface of the cover layer 2) in the depth direction. This is a range in consideration of a spherical aberration correction.

FIG. 1 shows an example in which information recording layers are disposed at positions 70 μm to 260 μm from the disc surface.

As a matter of course, when the range of position in the depth direction is under the same condition, larger numbers of information recording layers can be formed as the layer-to-layer distance is reduced.

Meanwhile, in each of the information recording layers, recording on the basis of the hole mark is performed while tracking servo is ensured by using the guide channel disposed in the cover layer 2. Therefore, the hole mark line formed in the information recording layer is formed into a spiral shape when viewed from a disc plan view direction.

The layer structure composed of the cover layer 2 to the bulk layer 5, as described above, is formed on the substrate 6.

<2. Recording and Reproduction with Respect to Optical Recording Medium>

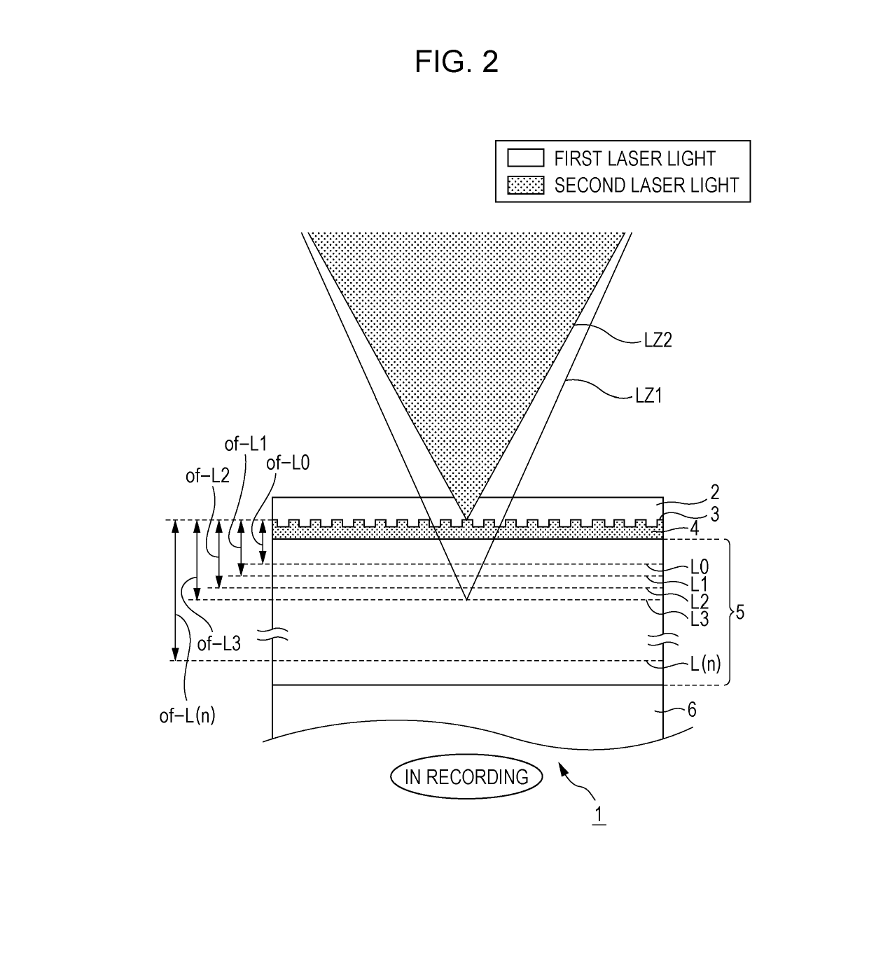

Operations in recording/reproduction with respect to the above-described optical recording medium 1 will be described with reference to FIG. 2.

The optical recording medium 1 is irradiated with a first laser light LZ1 to form recording marks and reproduce the information from the recording marks and, in addition, a second laser light LZ2 serving as servo light having a wavelength different from the wavelength of the first laser light LZ1.

These first laser light LZ1 and second laser light LZ2 are applied to the optical recording medium 1 through a common objective lens in a recording and reproduction apparatus.

Here, as shown in FIG. 1, the bulk layer 5 in the optical recording medium 1 is not provided with a reflection surface having a guide channel composed of pit, groove, or the like at the position of each layer for recording in contrast with a multilayer disc of an optical disc, e.g., DVD or Blue-ray Disc.

Consequently, in recording when a mark has not yet be formed, the focus servo and the tracking servo of the first laser light LZ1 cannot be performed by using the reflected light of the first laser light LZ1 itself.

from this point of view, in recording into the optical recording medium 1, both the tracking servo and the focus servo of the first laser light LZ1 are performed by using the reflected light of the second laser light LZ2 serving as the servo light.

Then, for this purpose, a mechanism capable of performing focus control of the first laser light LZ1 and the second laser light LZ2 independently is disposed in the recording and reproduction apparatus.

In the recording, the second laser light LZ2 is focused on the selective reflection film 3 (guide channel-formed surface). Under that condition, focus control of the first laser light LZ1 is performed in such a way that an offset of shown in FIG. 2 is ensured with reference to the selective reflection film 3 (guide channel-formed surface).

In the drawing, an example of each offset of in accordance with the case where information recording layers LO to L(n) are set in the bulk layer 5 is shown. That is, in the shown case, an offset of-L0 is set corresponding to the layer position of the information recording layer L0, an offset of-L1 is set corresponding to the layer position of the information recording layer L1, . . . and an offset of-L(n) is set corresponding to the layer position of the information recording layer L(n).

The focus mechanism for the first laser light LZ1 is driven using the values of these offsets of and, thereby, the position of formation of the mark (recording position) in the depth direction can be selected appropriately from the layer position of the information recording layer L0 to the layer position of the information recording layer L(n).

In addition, the tracking servo with respect to the first laser light LZ1 in the recording is realized by taking advantage of the point that the first laser light LZ1 and the second laser light LZ2 are applied through the common objective lens, as described above, and performing the tracking servo of the objective lens by using the reflected light of the second laser light LZ2 from the selective reflection film 3.

The first laser light LZ1 is modulated on the basis of the recording data and is applied to the position of a predetermined information recording layer while the servo control is performed as described above, so that a mark line on the basis of voids is formed.

On the other hand, in the state of reproduction, the information recording layer L is disposed in the bulk layer 5, as shown in FIG. 1, so that the reflected light of the first laser light LZ1 from such an information recording layer L can be obtained. Consequently, in reproduction, the focus servo with respect to the first laser light LZ1 is performed utilizing the reflected light of the first laser light LZ1 itself.

Meanwhile, in the reproduction, the tracking servo with respect to the first laser light LZ1 is realized by performing the tracking servo of the objective lens on the basis of the reflected light of the second laser light LZ2.

Here, in the reproduction as well, in order to read the absolute position information recorded on the guide channel-formed surface serving as the selective reflection film 3, the focus servo•tracking servo with respect to the second laser light LZ2 is performed aiming at the above-described guide channel-formed surface (guide channel).

That is, in the reproduction as well, as for position control of the objective lens, the focus servo•tracking servo of the second laser light LZ2 on the basis of the reflected light of the second laser light LZ2 is performed aiming at the above-described guide channel-formed surface (guide channel) in the same manner as in the recording.

In this regard, as for the tracking servo with respect to the first laser light LZ1 in the reproduction, the tracking servo may be performed by controlling the objective lens on the basis of the reflected light of the first laser light LZ1 from the recording mark line of hole marks.

In addition, the address information can be read from the recording mark line during reproduction at least after a seek.

Therefore, it is considered that the second laser light LZ2 is not used in the reproduction.

In the state in which the above-described servo control is performed, the first laser light LZ1 is applied to some information recording layer, and the information of the mark line on the basis of voids is obtained as reflected light information thereof. The signal on the basis of the reflected light information is subjected to a predetermined decoding processing, so as to obtain reproduction data.

### <3. Relationship Between Void and Noise and Suitability for Bulk Layer Material>

In the above-described information recording by forming voids in the bulk layer 5, formation of high-quality voids leads to a noise reduction in reproduction.

A primary component of a noise in a reproduction signal from a recording mark on the basis of a hole (void) is contamination (soot) generated in decomposition of an organic material constituting a recording layer due to heat or light.

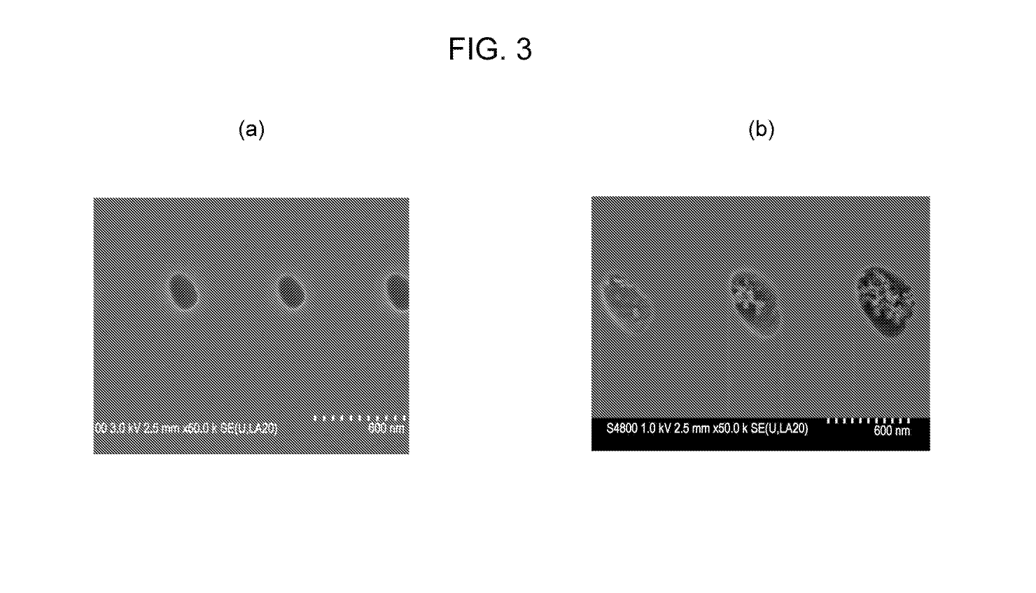

FIG. 3 (a) and FIG. 3 (b) show photographic images of clean voids including no soot and voids including soot having a cluster structure, respectively. The void in FIG. 3 (a) is an example exhibiting a noise level of 0 dB or less and the void in FIG. 3 (b) is an example exhibiting a noise level of 10 dB or more.

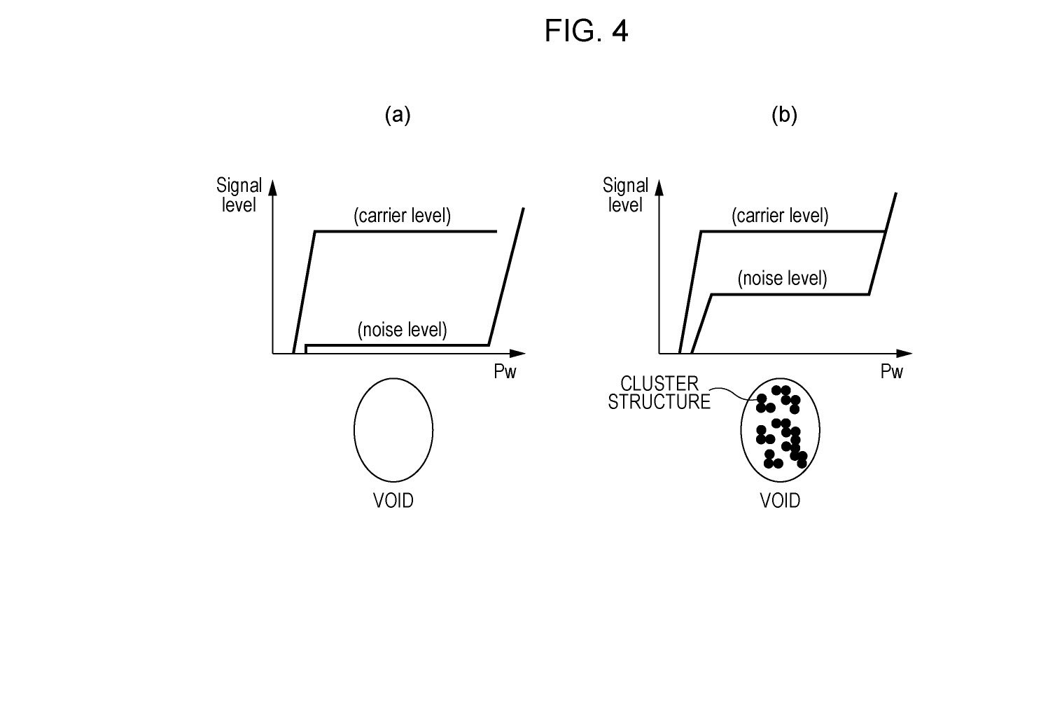

FIG. 4 (a) and (b) show a difference in the signal level depending on presence or absence of soot (cluster structure).

A carrier level depends on a diameter of the void as well. However, the noise level does not change depending on the void diameter basically.

It is shown that the noise level increases as the cluster structure (soot) increases even when the void diameter is the same.

Consequently, it is possible to reduce noises in a reproduction signal by forming a void including reduced soot and having a clean shape.

In order to remove soot, the organic material constituting the recording layer may be subjected to complete combustion. For this purpose, it is effective to increase the oxygen element ratio in the bulk layer and, thereby, facilitate gasification of the organic material.

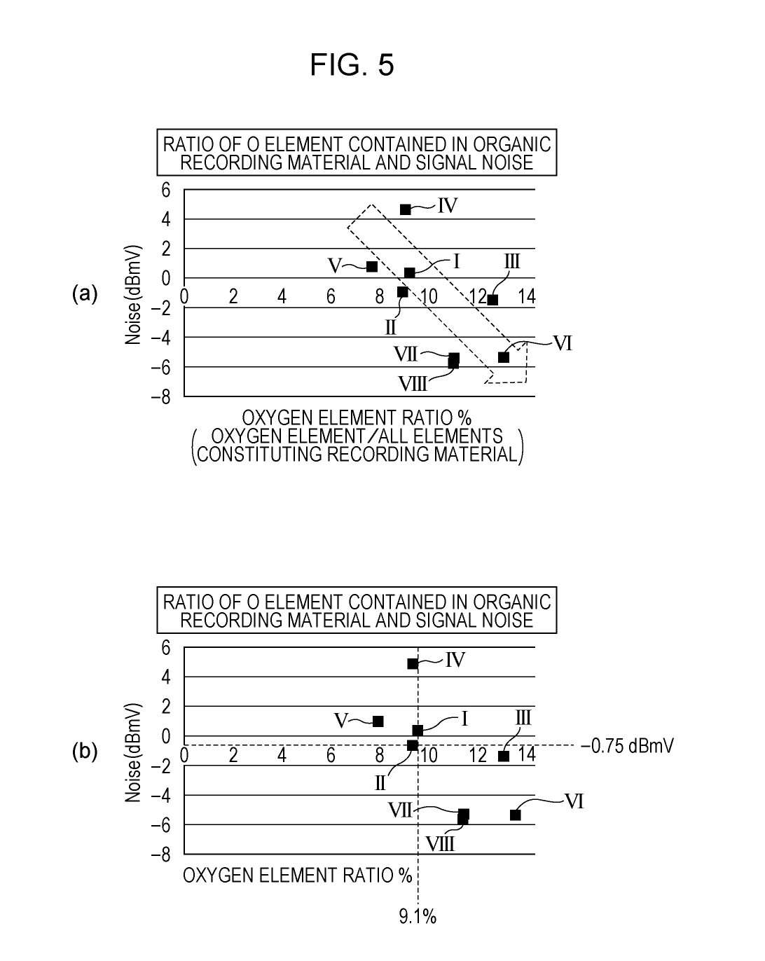

FIG. 5 (a) shows the relationship between the oxygen element ratio contained in the organic recording material and the signal noise.

I to VIII represent independently some organic material. Then, the horizontal axis represents the oxygen element ratio and the vertical axis represents the noise level (dBmV) of reproduction signal, where the bulk layer 5 is formed from the organic material concerned.

Here, the organic materials I to V are as described below.

### I: Polycarbonate (PC)

II: Amorphous polyarylate (PAR)

### III: Polyethersulfone (PES)

### IV: Polyphenylsulfone (PPSU)

### V: Polysulfone (PSU)

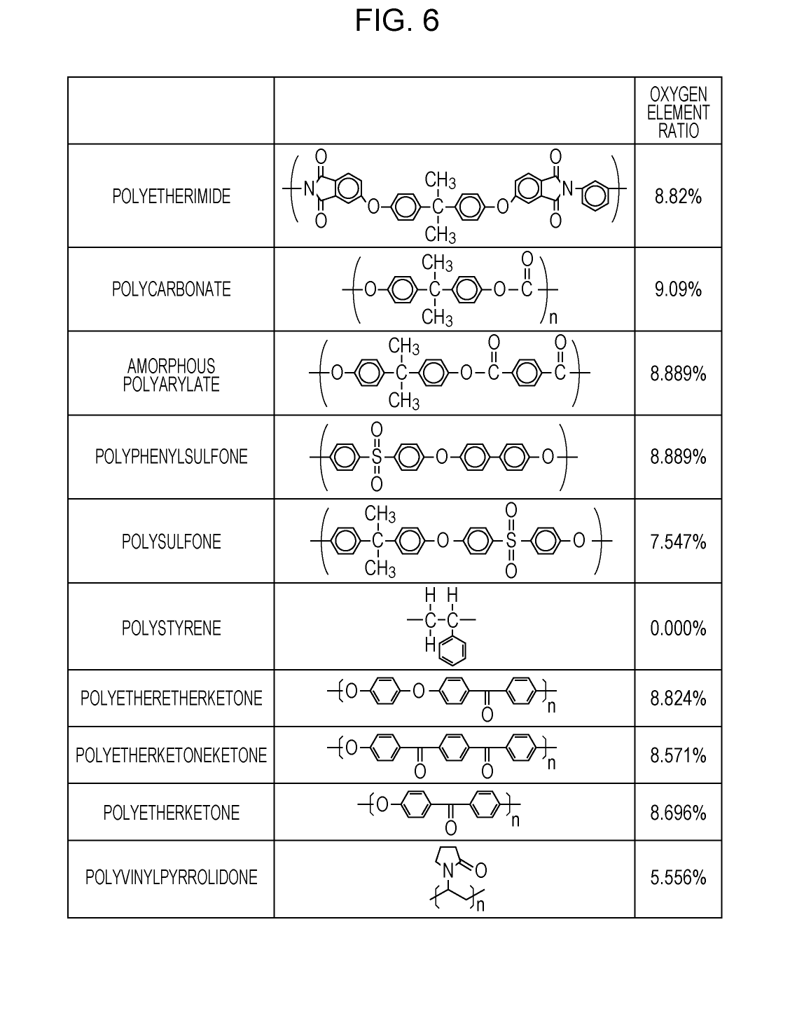

The oxygen element ratio refers to a ratio of oxygen element to all elements constituting the bulk layer 5 serving as the recording layer. In the case where the recording layer is formed from a single resin material, the oxygen element ratio is the ratio of oxygen element to a total number of constituent elements of the material concerned. For example, as is exemplified in FIG. 6, the constituent elements of polycarbonate represented by Material I are C: 16, O: 3, and H: 14 and, therefore, oxygen element ratio=3/(16+3+14)=9.09% holds good.

Likewise, oxygen element ratios are determined and Material II: amorphous polyarylate (PAR) results in 8.889%, Material III: Polyethersulfone (PES) results in 0.125, Material IV: Polyphenylsulfone (PPSU) results in 8.889%, and Material V: Polysulfone (PSU) results in 7.547%.

This FIG. 5 (a) shows the noise levels in the case where the individual organic materials are employed. As is observed from a broken line arrow, the noise level tends to decrease as the oxygen element ratio increases.

That is, it is understood that use of an organic material having a high oxygen element ratio as the material for the bulk layer 5 facilitates gasification of the organic material in void formation and, thereby, a void including reduced soot can be formed, as shown in FIG. 3(a).

Then, the degree of the oxygen element ratio of the organic material suitable for the material for the bulk layer 5 will be examined.

For example, in the case where Materials I (PC) and II (PAR) shown in FIG. 5 (a) are used for the bulk layer 5, it is difficult to obtain BER (bit error ratio)<10⁻⁴ required of Blu-ray Disc (Blu-ray Disc (registered trademark)) in consideration of the noise levels of Materials I and II.

FIG. 5 (b) is a graph having the same content as that of FIG. 5 (a). However, the condition required for obtaining BER<10⁻⁴ is the noise level of −0.75 dBmV or less. For that purpose, it is necessary that the oxygen element ratio be 9.1% or more.

That is, in the case where a simple substance of some organic material is used as the material for the bulk layer 5, an organic material having an oxygen element ratio of 9.1 or more is suitable.

<4. Bulk Layer Material Made from Resin>

Examples of thermoplastic resins and thermosetting resins serving as the material for the bulk layer 5 are mentioned.

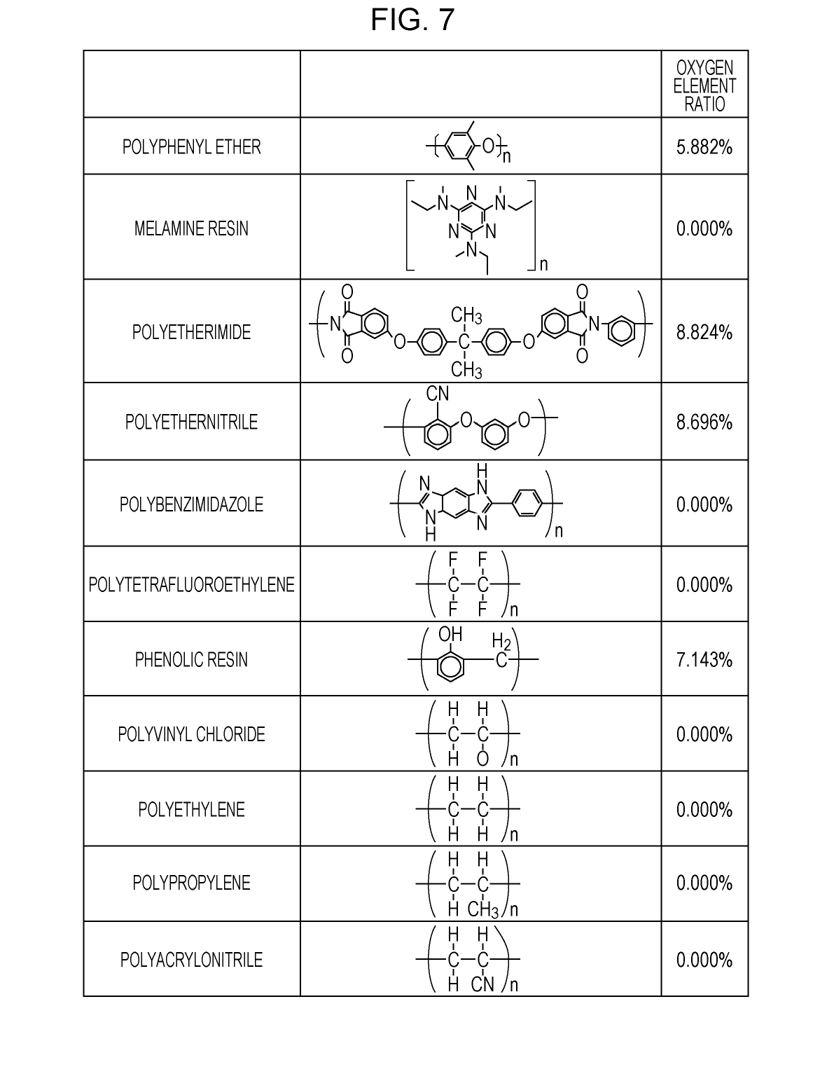

In this regard, FIG. 6 and FIG. 7 show examples of resins which may become candidates of the material for the bulk layer 5 but which have oxygen element ratios of less than 9.1%. The oxygen element ratios of the individual materials are as described below.
Polyetherimide: 8.82%
Polycarbonate: 9.09%
Amorphous polyarylate: 8.889%
Polyphenylsulfone: 8.889%
Polysulfone: 7.547%
Polystyrene: 0.000%
Polyetheretherketone: 8.824%
Polyetherketoneketone: 8.571%
Polyetherketone: 8.696%
Polyvinylpyrrolidone: 5.556%
Polyphenyl ether: 5.882%
Melamine resin: 0.000%
Polyetherimide: 8.824%
Polyethernitrile: 8.696%
Polybenzimidazole: 0.000%
Polytetrafluoroethylene: 0.000%
Phenol resin: 7.143%
Polyvinyl chloride: 0.000%
Polyethylene: 0.000%
Polypropylene: 0.000%
Polyacrylonitrile: 0.000%

These resins have oxygen element ratios of less than 9.1%. Therefore, simple substances of these resins or even mixtures of a plurality of resins are not suitable for the material for the bulk layer 5 according to the present embodiment.

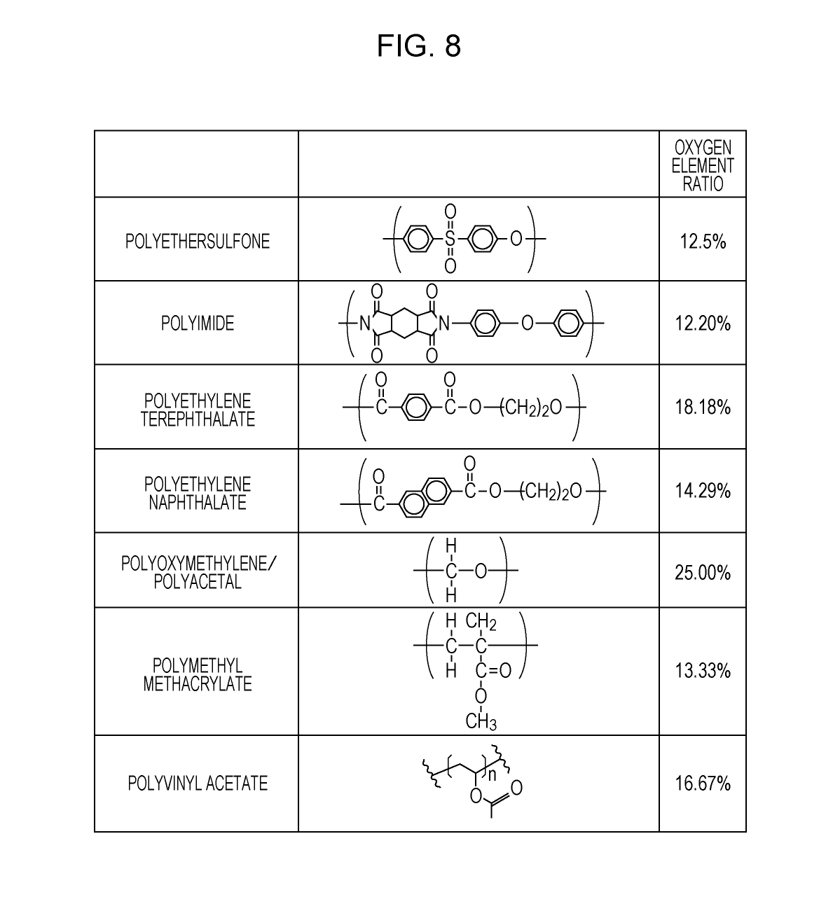

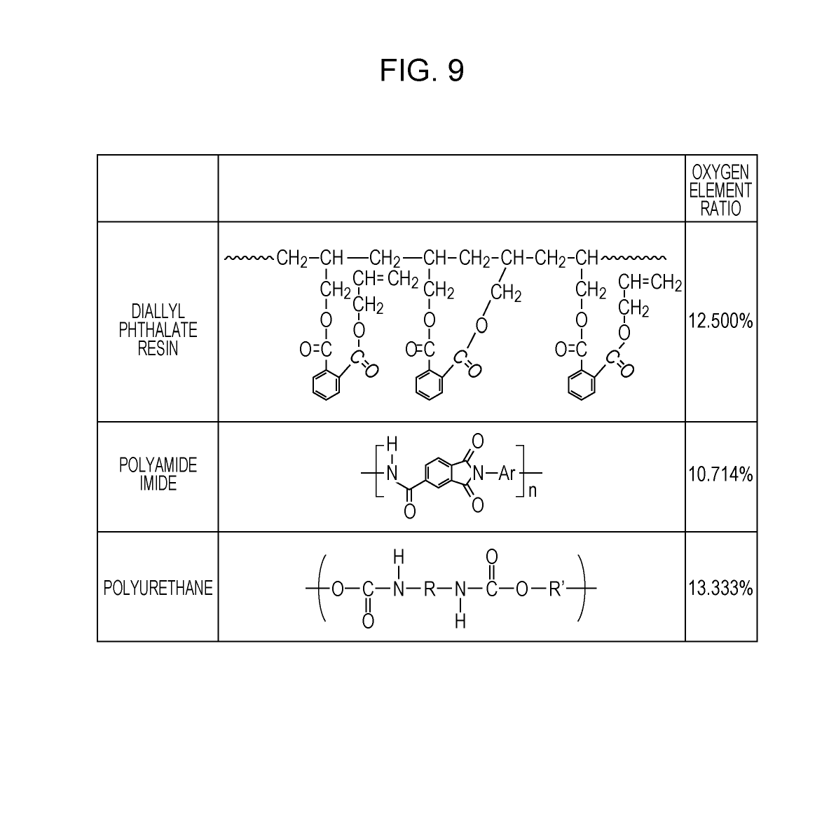

Meanwhile, FIG. 8 and FIG. 9 show examples of resins which have oxygen element ratios of 9.1% or more. The oxygen element ratios of the individual materials are as described below.
Polyethersulfone: 12.5%
Polyimide: 12.20%
Polyethylene terephthalate: 18.18%
Polyethylene naphthalate: 14.29%
Polyoxymethylene/polyacetal: 25.00%
Polymethyl methacrylate: 13.33%
Polyvinyl acetate: 16.67%
Diallyl phthalate resin: 12.50%
Polyamide imide: 10.714%
Polyurethane: 13.333%

Simple substances of the above-described resins have oxygen element ratios of 9.1% or more. Therefore, the simple substances thereof are suitable for the material for the bulk layer 5.

from the viewpoint of the simple substance of the resin, the upper limit of the oxygen element ratio is 25.00% (polyoxymethylene).

The bulk layer 5 of the optical recording medium 1 of the embodiment is formed from a resin having an oxygen element ratio of 9.1% or more. In the case where the bulk layer 5 is formed from a resin simple substance, as for the upper limit of the oxygen element ratio of the material, it can be considered that the oxygen element ratio of the material having a maximum oxygen content among available materials is the upper limit. Therefore, in the case where the candidate resins are the above-described resins, it can be considered that the upper limit of the oxygen element ratio is 25.00%.

However, in the case where a low-molecular compound is added to the resin, the low-molecular compound can be made 25.00% or more, as described later.

In this regard, the bulk layer 5 is not necessarily formed from a resin simple substance, but a mixture of a plurality of resins may be employed as a material for the bulk layer 5.

In that case, use of a plurality of resins, which have oxygen element ratios of 9.1% or more, shown in FIG. 8 and FIG. 9 satisfy the condition that the ratio of oxygen element to all elements constituting the bulk layer 5 is 9.1% or more.

Meanwhile, a material in which the ratio of oxygen element to all elements constituting the bulk layer 5 is 9.1% or more can also be realized by combining the resins, which have oxygen element ratios of less than 9.1%, shown in

FIG. 6 and FIG. 7 and the resins, which have oxygen element ratios of 9.1% or more, shown in FIG. 8 and FIG. 9.

That is, even a resin having an oxygen element ratio of less than 9.1% alone may be used as a material for the bulk layer 5 of the present embodiment by being mixed with a plurality of types of resin.

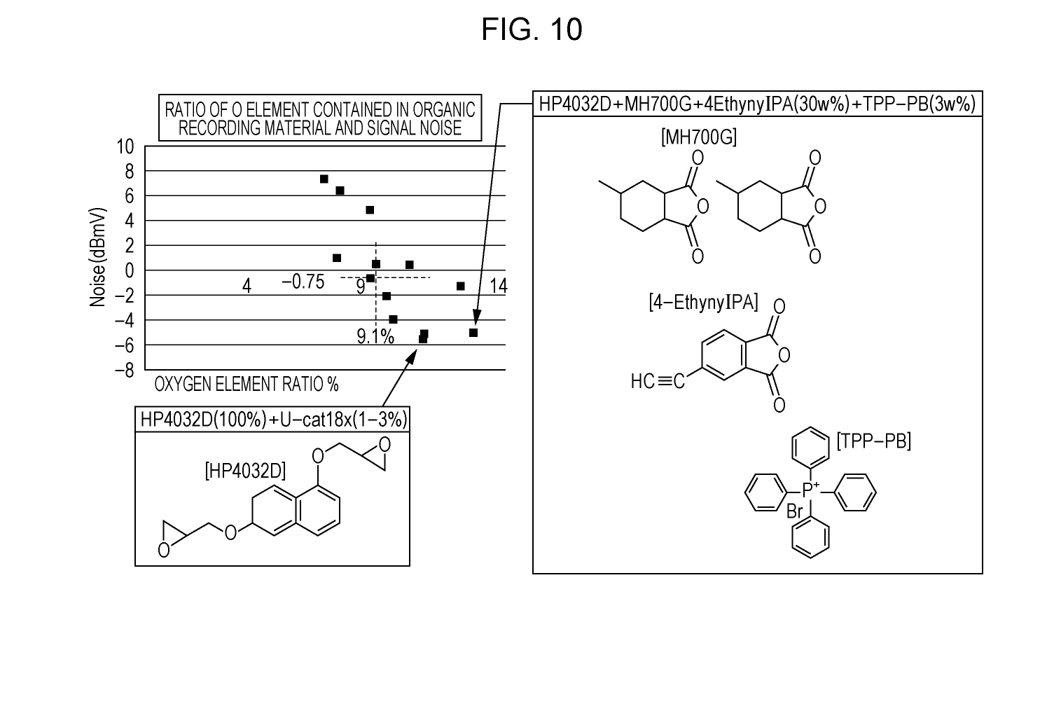

Besides the diallylphtharate resin described above as an example of the thermosetting resin, FIG. 10 shows epoxy resins as examples of the thermosetting resin having an oxygen element ratio of 9.1% or more.

For example, HP4032D+MH700G+4EthynylPA (30 w %)+TPP-PB (3 w %) and HP4032D (100%)+U-cat18x (1-3%) have oxygen element ratios of 9.1% or more, as shown in the drawing, and are suitable for the material for the bulk layer 5.

The structures of HP4032D, MH700G, 4EthynylPA, and TPP-PB are as shown in the drawing. In this regard, U-cat18x refers to “Specialty amine U-cat18x produced by San-Apro Ltd.”

In this regard, use of the thermoplastic resin has the following advantages.
The formability and the mass productivity are good and forming can be performed by various processes.
For example, as for injection forming, which is one of processes, the tact time is small and a cost reduction is expected.
In the case where a low-molecular compound is added to the resin, as described later, the low-molecular compound can be added with good dispersibility by employing a solvent casting method in forming.

Meanwhile, use of the thermosetting resin has the following advantages.
The thermosetting resin is polymerized from a monomer by heat and, therefore, the properties (strength•cross-link structure) of a matrix resin can be controlled by adjusting the curing agent, the temperature, and the like.
A low environmental load can be expected because a solvent is not used in the process.
An original state is a monomer (primarily liquid in many cases) and, therefore, in the case where a low-molecular compound is added, as described later, performance of addition and dispersion is good.
   <5. Bulk Layer Material Made from Resin+Low-Molecular Compound>

Next, a material, in which a low-molecular compound is added to a resin, for the bulk layer 5 will be described.

That is, in the example, the bulk layer 5 is formed from a material in which a low-molecular compound is added to an organic material and in which the ratio of oxygen element to all elements constituting the bulk layer 5 is 9.1% or more.

The oxygen element ratio is increased by adding the low-molecular compound to the resin and, thereby, a reduction in noises of the reproduction signal can also be realized.

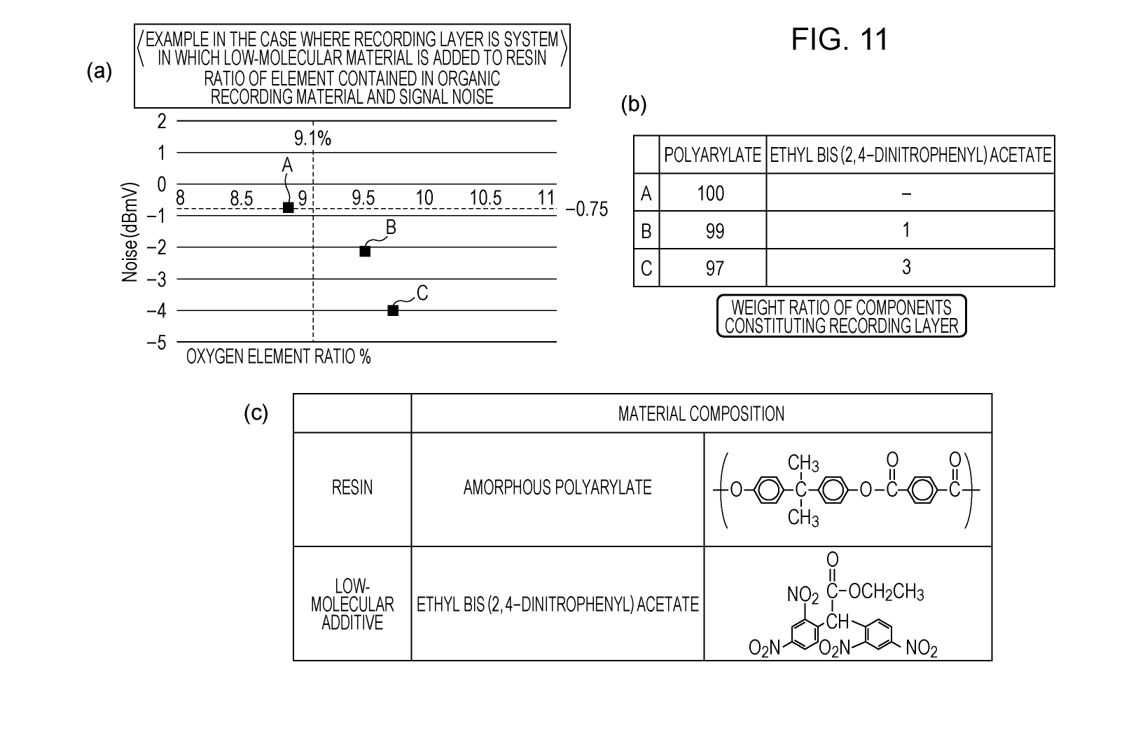

FIG. 11 (a) shows the oxygen element ratios and the noise levels of Materials A, B, and C.

Material A is an amorphous polyarylate simple substance having an oxygen element ratio of 8.889%.

As shown in FIG. 11 (c), ethyl bis(2,4-dinitrophenyl)acetate is used as an additive thereto.

As shown in FIG. 11 (b), Material B is a material in which ethyl bis(2,4-dinitrophenyl)acetate is added to amorphous polyarylate at a weight ratio of 99:1.

Material C is a material in which ethyl bis(2,4-dinitrophenyl)acetate is added to amorphous polyarylate at a weight ratio of 97:3.

As the amount of addition increases, the oxygen element ratio increases and the noise level decreases along with that, as shown in FIG. 11 (a).

That is, even when a resin simple substance having an oxygen element ratio of less than 9.1% is used, the oxygen element ratio is made 9.1% or more by adding an appropriate amount of an appropriate low-molecular compound, so that the bulk layer 5 suitable for noise reduction can be formed.

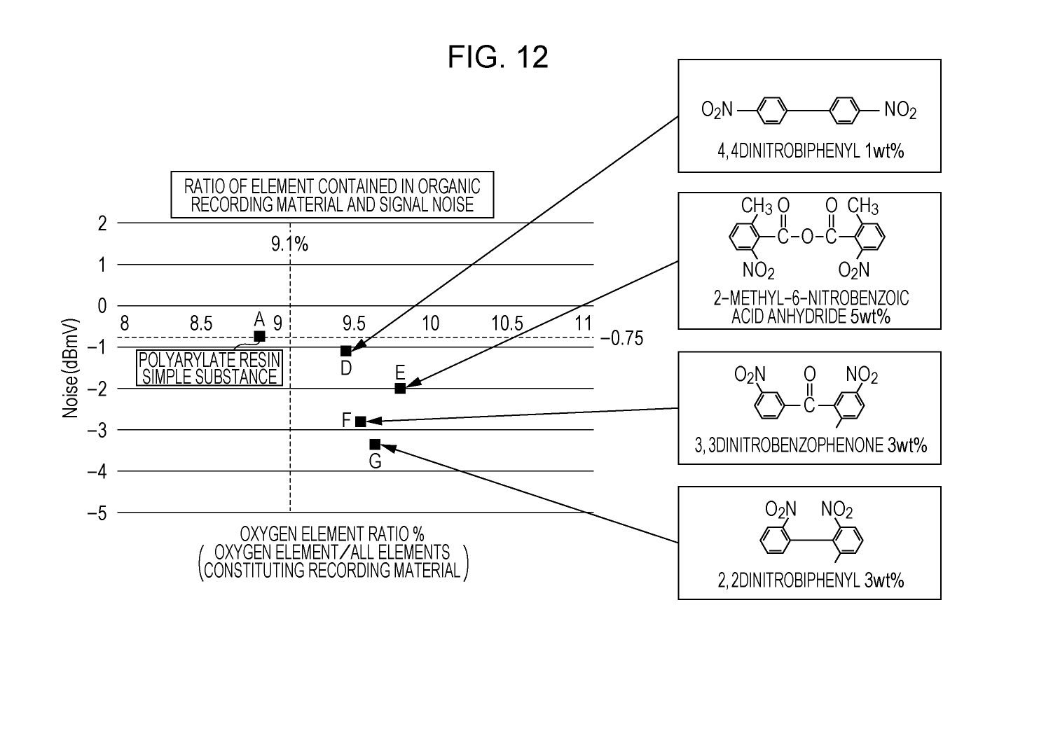

FIG. 12 shows a further example. Materials D, E, F, and G shown in this FIG. 12 are also materials in which low-molecular compounds are added to amorphous polyarylate.

Material D is a material in which 1 percent by weight of 4,4-dinitrobiphenyl is added.

Material E is a material in which 5 percent by weight of 2-methyl-6-nitrobenzoic acid anhydride is added.

Material F is a material in which 3 percent by weight of 3,3-dinitrobenzophenone is added.

Material G is a material in which 3 percent by weight of 2,2-dinitrobiphenyl is added.

These Materials D, E, F, and G have oxygen element ratios of 9.1% or more and are suitable for the material for the bulk layer 5.

As described above, the material having an oxygen element ratio of 9.1% or more for the bulk layer 5 can be realized by adding the low-molecular compound to the resin material.

As a matter of course, the resin materials, which have oxygen element ratios of 9.1% or more, shown in FIG. 8, FIG. 9, and FIG. 10 may be used as a base, and the low-molecular compound may be added thereto. In this case, the oxygen element ratio can be made 25% or more. As the oxygen element ratio increases, the bulk layer 5 advantageous to noise level can be formed.

Furthermore, the selectivity of usable resins can increase because it is possible that the resin, which have oxygen element ratios of less than 9.1%, shown in FIG. 6 and FIG. 7 are used as a base, the low-molecular compound is added and, thereby, a material having an oxygen element ratio of 9.1% or more is realized.

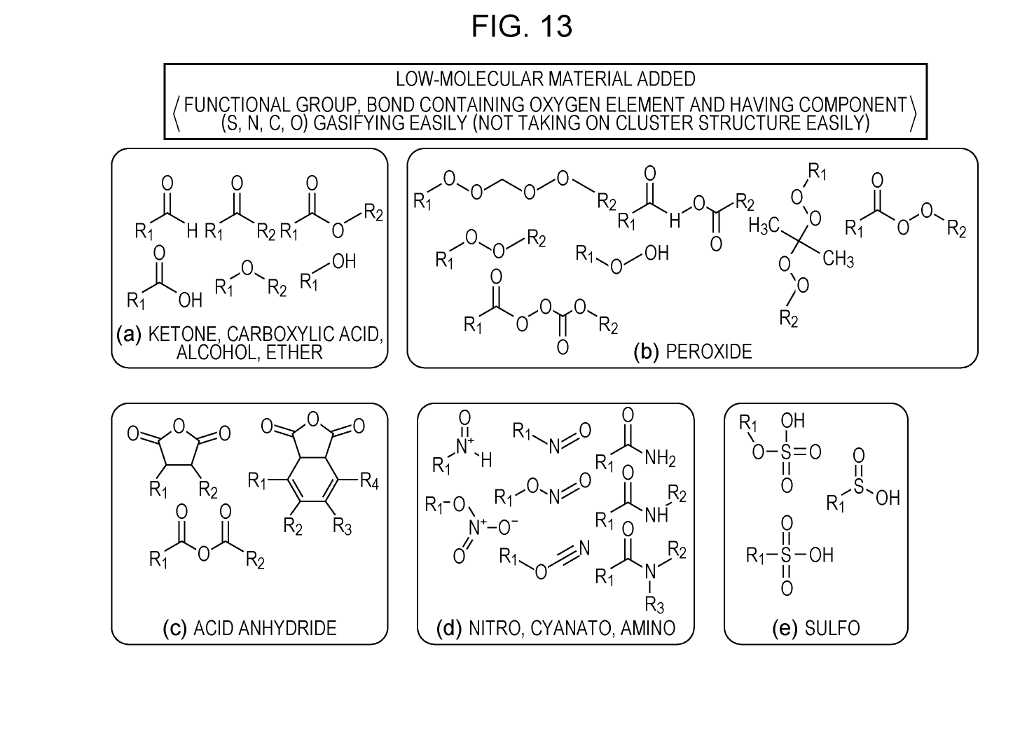

Low-molecular compounds serving as additives are variously considered. FIG. 13 shows examples.

As for the additive, functional groups and bonds containing an oxygen element and having a component S, N, C, O gasifying easily are preferable. For example, ketones, carboxylic acids, alcohols, and ethers shown in FIG. 13 (a), peroxides shown in FIG. 13 (b), acid anhydrides shown in FIG. 13 (c), nitro, cyanato, and amino shown in FIG. 13 (d), and sulfo shown in FIG. 13 (e) are considered to come under the condition.

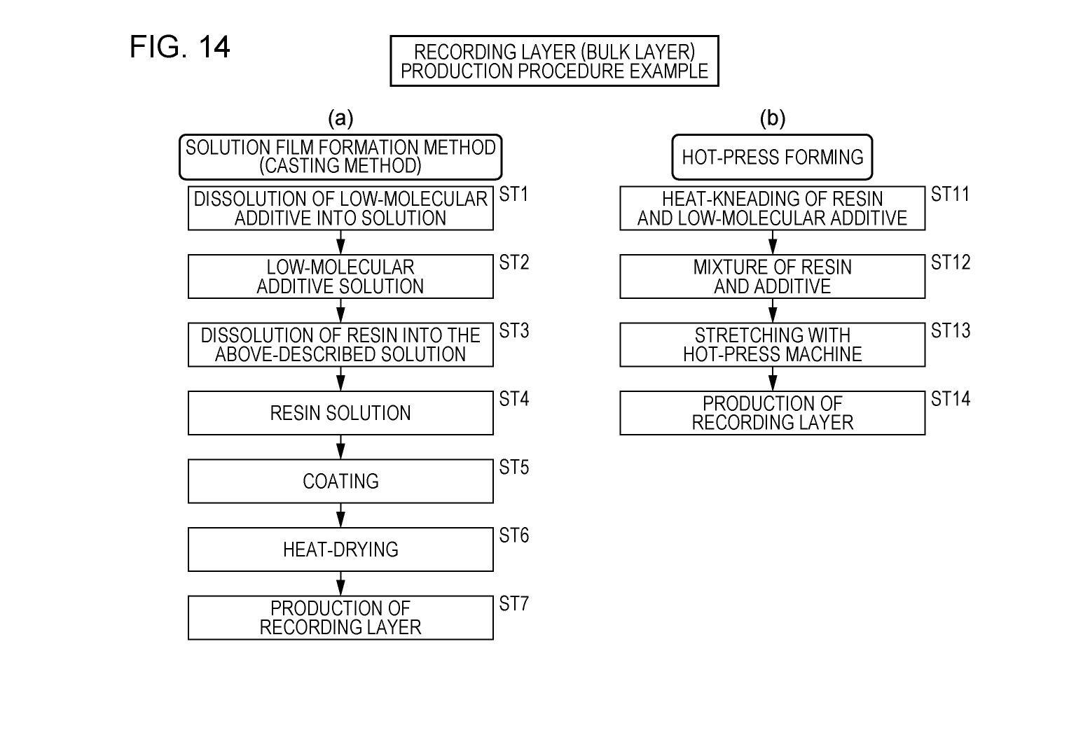

FIG. 14 shows examples of production procedures of the bulk layer 5 in the case where a material in which a low-molecular compound is added to a resin is used.

FIG. 14 (a) shows a so-called solution film formation method.

Initially, the low-molecular compound additive is dissolved into a solvent (ST1). According to this, a low-molecular additive solution is obtained (ST2). Subsequently, a resin is dissolved into the low-molecular additive solution (ST3). According to this, a resin solution is obtained (ST4).

Then, the resin solution is applied to the substrate 6 (ST5), and is heat-dried (ST6). After drying, a recording layer is produced as the bulk layer 5 on the substrate 6 (ST7).

FIG. 14 (b) shows a technique of hot-press forming.

Initially, the resin and the low-molecular additive are heat-mixed (ST11). According to this, a mixture of the resin and the additive is obtained (ST12). Subsequently, stretching is performed with a hot-press machine (ST13). The stretched mixture is used as the bulk layer 5 serving as a recording layer (ST14).

Up to this point, the material for the bulk layer 5 in the optical recording medium 1 of the embodiment has been described. However, the material usable as a recording layer in the optical recording medium according to the present invention is not limited to the above-described materials.

In the case where a resin simple substance is used, the recording layer is formed from a resin having an oxygen element ratio of 9.1% or more.

In the case where a plurality of resins are used, a material in which a plurality of resins having oxygen element ratios of 9.1% or more are mixed may be used.

Alternatively, a resin having an oxygen element ratio of less than 9.1% and a resin having an oxygen element ratio of 9.1% or more may be mixed in such a way that, as a result, the oxygen element ratio of a recording layer becomes 9.1% or more.

In the case where a low-molecular compound is added to a resin, the resin serving as a base may be a resin having an oxygen element ratio of 9.1% or more or be a resin having an oxygen element ratio of less than 9.1%. It is enough that the oxygen element ratio becomes 9.1% or more by addition of a low-molecular compound.

The material may be selected in such a way as to satisfy these conditions.

In this regard, the structure shown in FIG. 1 is no more than an example of the structure of the optical recording medium according to the present invention. The structural example of the bulk type optical recording medium in which recording is performed on the basis of void formation is variously considered.

Considered examples include a structure in which a guide channel having an uneven pattern is disposed between a bulk layer 5 and a substrate 6 and a structure in which a guide channel is not present.

The present invention can be further applied to optical recording medium having other shapes, e.g., a card type optical recording medium, besides the disc-shaped optical recording medium.

### EXPLANATION OF REFERENCE NUMERALS

1 recording medium, 2 cover layer, 3 selective reflection film, 4 intermediate layer, 5 bulk layer, L0-L(n) information recording layer, 6 substrate

1. An optical recording medium comprising a bulk type recording layer in which hole marks are formed by laser light irradiation, wherein the recording layer contains an organic material having an oxygen element ratio of 9.1% or more.

2. The optical recording medium according to claim 1, wherein the organic material is a thermoplastic resin.

3. The optical recording medium according to claim 1, wherein the organic material is a thermosetting resin.

4. The optical recording medium according to claim 1, wherein the oxygen element ratio of the organic material is 25% or less.

5. The optical recording medium according to claim 1, wherein the organic material is any one of polyethersulfone, polyimide, polyethylene, polyoxymethylene, polymethyl methacrylate, polyvinyl acetate, diallyl phthalate, polyamide imide, and polyurethane.

6. The optical recording medium according to claim 1, wherein the recording layer contains a material in which a plurality of resins having oxygen element ratios of 9.1% or more are mixed.

7. An optical recording medium comprising a bulk type recording layer in which hole marks are formed by laser light irradiation, wherein the recording layer contains a material in which a low-molecular compound is added to a resin and which has an oxygen element ratio of 9.1% or more.

8. The optical recording medium according to claim 7, wherein the material is a material having an oxygen element ratio of 9.1% or more adjusted by adding a low-molecular compound to a resin having an oxygen element ratio of less than 9.1%.

9. The optical recording medium according to claim 7, wherein the material is a material having an oxygen element ratio of 9.1% or more adjusted by adding a low-molecular compound to a resin having an oxygen element ratio of 9.1% or more.
